(19) United States
(12) Patent Application Publication
(10) Pub. No.: US 2006/0199544 A1
(43) Pub. Date: Sep. 7, 2006

(54) Method for exploiting the diversity across frequency bands of a multi-carrier cellular system

(75) Inventors: Sudhir Ramakrishna, New York, NY (US); Ashok N. Rudrapatna, Basking Ridge, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/071,647

(22) Filed: Mar. 2, 2005

(51) Int. Cl. H04B 17/00

(52) U.S. Cl. 455/67.11

(57) ABSTRACT

A method for exploiting the diversity of a multi-carrier cellular system's frequency bands, for purposes of increasing network capacity, involves a base station transmitting a pilot signal on each frequency band to a plurality of mobile stations. Each mobile station measures the SIR of each pilot signal on the frequency bands, and this information is transmitted back to the base station. The base station may be configured to utilize this information in a number of manners, all of which are intended to increase channel capacity. For example, on each frequency band, the base station may transmit data signals only to those mobiles stations with the best signal quality on that frequency band. Additionally, the base station may transmit signals to one or more mobile stations across one or more frequency bands simultaneously, with transmissions on each band being adapted to the corresponding channel conditions.

### FIELD OF THE INVENTION

The present invention relates to telecommunications and, more particularly, to wireless communications systems.

### BACKGROUND OF THE INVENTION

In a cellular system or network utilizing a multi-carrier transmission mechanism, the information to be communicated on the forward link can be transmitted on many frequency bands (i.e., carriers) simultaneously, in parallel to several mobile stations, and/or to one mobile station as the traffic and user load warrant. In communicating with a particular mobile station, the base station transmitter retains the flexibility of transmitting on one or more of the frequency bands within the total bandwidth. In other words, the number of frequency bands on which the base station transmits signals to a particular mobile station may be less than the total number of available frequency bands. Such a system is henceforth referred to as a multi-carrier (“MC”) cellular system or network.

The path loss between a base station transmitter and a mobile station is a measure of the attenuation experienced by a radio signal in propagating from the base station transmitter to the mobile receiver. In a mobile environment, this typically will be a time varying quantity.

The path loss in a base station to mobile station link is inversely proportional to the signal-to-interference ratio (“SIR”) for that link; all other quantities remaining the same, a lower path loss implies a higher SIR for that link. The SIR determines the ability of the receiver to extract the intended information signal out of the total received power. A higher SIR implies a better ability to perform this useful signal extraction. More specifically, in a communications system, the total received power impinging on a receiver consists of three parts: (a) the transmit power of the information signal intended for the receiver; (b) partial powers of signals intended for other users (this could be either due to deficiencies in hardware leading to imperfect isolation of the transmitted signals, or due to deliberate design in introducing controlled mixing of the signals meant for different users by the transmitter, e.g., as in CDMA networks); and (c) random noise introduced by inefficiencies in the transmitting/receiving hardware or otherwise. The SIR is defined as the ratio of: (a)/((b)+(c)).

Due to several well-understood physical phenomena that affect the propagation of radio signals, the path loss is dependent on the frequency at which the signal transmission is made. Hence, in an MC system, the SIR at a mobile station is dependent on the frequency band of transmission. Each band over which a signal is sent to the mobile has a different path loss. If the base station had knowledge of which bands have lower path loss to a mobile, it could use this information advantageously.

### SUMMARY OF THE INVENTION

An MC cellular system or network includes a base station that communicates with a number of distributed mobile stations over a plurality of frequency bands. A method for exploiting the diversity of the cellular system's frequency bands, for purposes of increasing network capacity, involves the base station transmitting a pilot signal on each frequency band to the mobile stations. The mobile stations measure a quality or characteristic, e.g., SIR, of the pilot signals they receive across the various frequency bands. This information, or some function or portion thereof, is transmitted back to the base station on the reverse link. Thus, the base station is provided with an indication, for each mobile station, of the signal quality as perceived by that mobile station on each frequency band of the MC cellular system. Alternatively, the mobile stations may be configured to provide information relating to the signal quality, e.g., measured pilot signal SIR, across only one or several of the frequency bands.

The base station may be configured to utilize the signal quality information in a number of ways, all of which are intended to increase the amount of data that can be transmitted by the base station per unit time, i.e., channel capacity. For example, on each frequency band, the base station may transmit data signals only to the mobile station(s) with the best signal quality on that frequency band. Additionally, the base station may transmit signals to one or more mobile stations across one or more frequency bands simultaneously, with transmissions on each band being adapted to the corresponding channel conditions. For the same total transmitted power by the base station in an MC cellular network, these solutions tailor the transmissions to the signal quality conditions across the transmission bandwidth, thus maximizing the amount of information transmitted. This will result in faster information transfers, leading to better system performance.

### BRIEF DESCRIPTION OF THE DRAWINGS

The present invention will be better understood from reading the following description of non-limiting embodiments, with reference to the attached drawings, wherein below:

FIG. 1 is a schematic diagram of an MC cellular network according to an embodiment of the present invention;

FIG. 2 is a frequency domain representation of a forward link in the MC cellular network;

FIG. 3 is a schematic diagram of a mobile station signal quality message; and

FIGS. 4-7 are flowcharts illustrating the steps of a method for exploiting frequency band diversity, according to various embodiments of the present invention.

### DETAILED DESCRIPTION

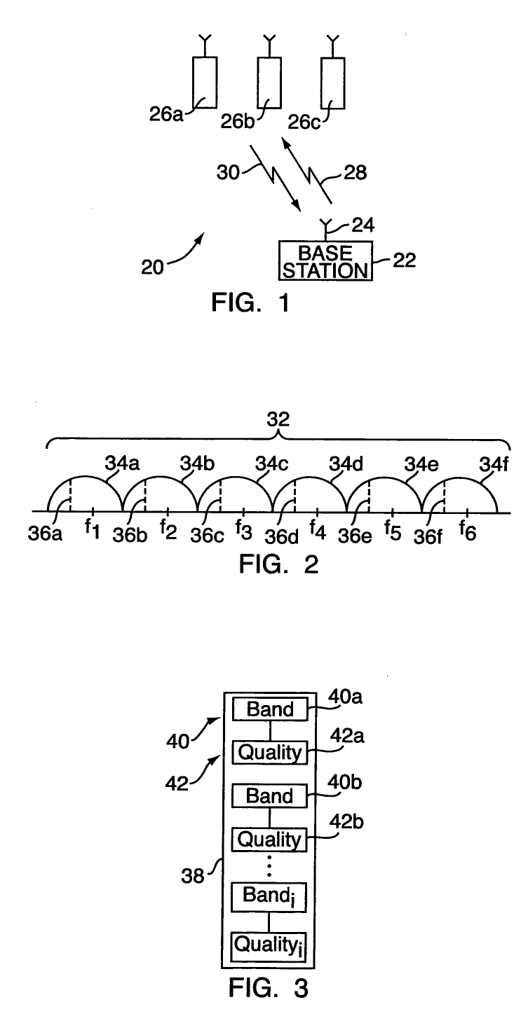

With reference to FIGS. 1-7, an embodiment of the present invention relates to a method for exploiting frequency band diversity in a multi-carrier (“MC”) cellular network 20, for purposes of increasing network capacity. The MC cellular network 20 includes, in part, a base station 22, which has one or more fixed/stationary transceivers and antennae 24 for wireless communications with a set of distributed mobile stations 26a-26c (e.g., mobile phones) that provide service to the network's users. The base station 22 is in turn connected to a mobile switching center (not shown) or the like, which serves a particular number of base stations depending on network capacity and configuration. The mobile switching center acts as the interface between the wireless/radio end of the network 20 and a public switched telephone network or other network(s), including performing the signaling functions necessary to establish calls or other data transfer to and from the mobile stations 26a-26c.

Transmissions from the base station 22 to the mobile stations 26a-26c are across a forward link 28, while transmissions from the mobile stations 26a-26c to the base station are across a reverse link 30. In the MC cellular network 20, the forward and/or reverse links will typically include a number of frequency bands within an overall link bandwidth. For example, FIG. 2 shows a possible frequency distribution of the forward link 28, where the forward link 28 has an overall bandwidth 32 that is divided into a number of frequency bands 34a-34f, each respectively centered around a frequency f₁-f₆.

The overall bandwidth 32 of the forward link will usually be a function of the total bandwidth allotted to the MC cellular network 20. Most cellular networks are configured according to one or more industry standards or protocols, which are in turn based on, in part, government frequency spectrum allocations. These standards or protocols dictate the total reverse and forward link bandwidth. For example, in certain cellular networks, each link may have a 1.25 MHz bandwidth. The total bandwidth 32 may be broken into a number of frequency bands 34, depending on the particular network and its configuration. Additionally, the frequency bands will not necessarily be non-overlapping, as shown in FIG. 2. More specifically, FIG. 2 shows a frequency distribution that might be expected in a multi-carrier CDMA (code division multiple access) system using non-overlapping frequency division multiplexing. However, in MC-CDMA or MC-DS-CDMA networks, both of which are more likely to be implemented in practice, the frequency bands 34 will usually overlap.

To optimize capacity (e.g., data throughput in bits/sec or symbols/sec) in the MC cellular network 20, the base station 22 is provided with information about the signal quality (e.g., SIR) across each frequency band 34 in the MC cellular network 20. Then, the base station 22 utilizes this information to modify and enhance the wireless communications between it and the mobile stations 26a-26c.

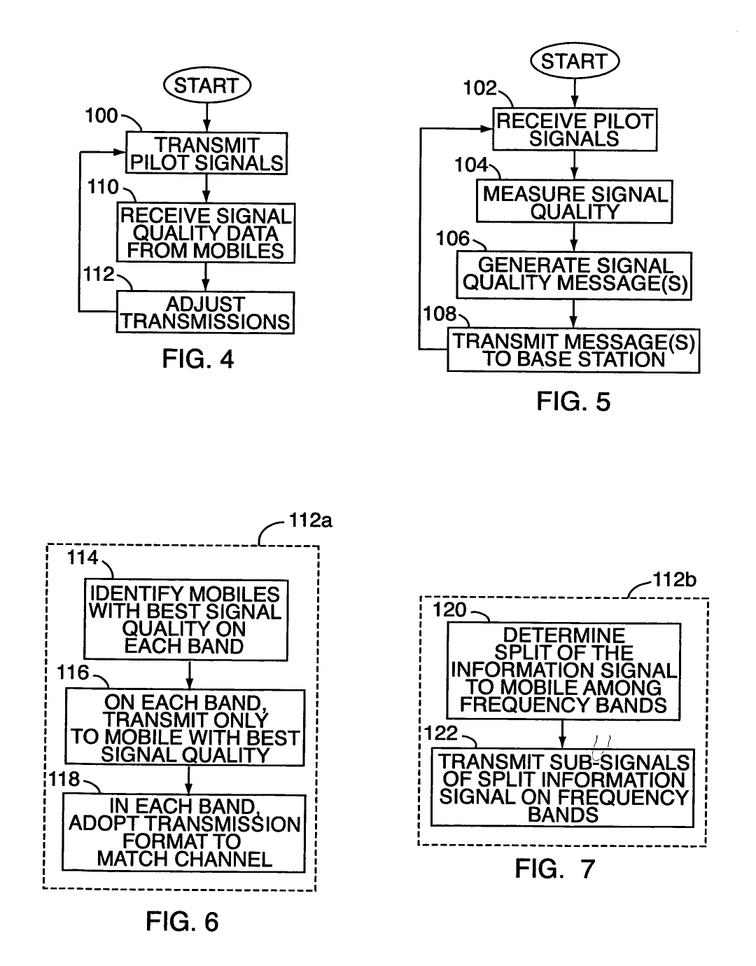

FIG. 4 shows an overview of the procedures carried out by the base station 22. At Step 100, the base station 22 transmits a known pilot signal 36a-36f on each frequency band 34a-34f of the MC cellular network 20, respectively. The pilot signal is a signal, the characteristics of which are known to both the transmitter and the receiver in a communication system, e.g., the base station and mobile units in the MC cellular network. This signal may be used to aid in synchronization, and may take the form of a single frequency signal within its respective frequency band 34, and identifiable as such by the mobile stations 26a-26c. The pilot signals 36 could also be akin to the pilot channel signal in a CDMA network, in which case they may share the entire respective frequency band with the other signals on that band. Also, the pilot signals are “common,” in the sense of being receivable by all the mobile stations 26a-26c in the system, i.e., broadcast across the whole sector or cell.

FIG. 5 shows an overview of the procedures carried out by each mobile station 26a-26c. At Step 102, the mobile station 26a-26c receives the pilot signals 36 transmitted by the base station 22, along with whatever other information/data is also transmitted from the base station to the mobile station on the forward link 28. At Step 104, the mobile station measures a quality or characteristic, e.g., SIR, of each pilot signal 36 it receives, on all the frequency bands 34 across the forward link bandwidth 32. As indicated above, this measurement may be the ratio of received pilot signal energy to total received energy or to total power spectral density in the frequency band 34. At Step 106, the mobile station 26a-26c generates one or more signal quality messages 38 (see FIG. 3).

The signal quality message(s) 38 includes signal quality information about each frequency band 34 received by the mobile station, namely, an identifier 40 that identifies the frequency band, and a quality descriptor 42 that conveys the measured quality or characteristic, or some pre-specified function of it, of the received pilot signal 36 in that frequency band. (Other information may also be provided.) For example, as shown in FIG. 3, the mobile station may generate an identifier 40a for frequency band 34a with an associated quality descriptor 42a for that band's pilot signal 36a, an identifier 40b for frequency band 34b with an associated quality descriptor 42b for that band's pilot signal 36b, and so on. As should be appreciated, the messages 38 will typically be pre-formatted binary strings, i.e., the identifier 40 will be a binary string identifying the frequency band, and the quality descriptor 42 will be a binary string representing, e.g., the pilot signal SIR. Also, the identifier 40 and quality descriptor 42 for each frequency band may be transmitted as a separate message 38, or the identifiers and quality descriptors for all the frequency bands may be periodically transmitted together as a single message 38. At Step 108, the mobile station transmits the signal quality message(s) 38 back to the base station 22 on the reverse link.

To save transmission resources, instead of reporting on the signal quality across every frequency band 34, the mobile stations 26a-26c may simply report information about the frequency band 34 with the best-observed SIR across the entire frequency bandwidth 32, including the SIR measured on that frequency band, or some function thereof. The information about the identifier of the frequency band with the best signal quality may be implicit, as in the case where the mobile station itself utilizes a multi-carrier scheme to transmit information to the base station 22, with each frequency band on the reverse link 30 having a correspondence with a certain forward link frequency band 34. In this case, the mobile station may indicate which forward link frequency band 34 has the best SIR by simply transmitting a quality descriptor 42 (i.e., SIR measurement information) to the base station 22 on the reverse link frequency band corresponding to the best forward link frequency band 34, without explicitly committing any resources to convey information explicitly identifying the best forward link frequency band 34, e.g., an identifier 40.

Alternatively, instead of reporting on the signal quality across every frequency band 34 or only one frequency band, the mobile stations 26a-26c may provide information on the signal quality across some number “n” of the frequency bands 34, where “n” is less than the total number of frequency bands 34. For example, the mobile stations 26a-26c may measure the SIR of the pilot signals on all the frequency bands 34, and then report on those “n” frequency bands whose pilot signals have the best measured SIR. As explained above, this reporting may be implicit with respect to the frequency band identifier.

Referring back to FIG. 4, at Step 110, the base station 22 receives signal quality information back from the mobile stations 26a-26c, e.g., the signal quality messages 38. This gives the base station information, for each mobile station 26a-26c, of the signal quality as perceived by that mobile station on some or all of the forward link frequency bands 34 of the MC cellular network 20. Finally, at Step 112, the base station 22 adjusts the transmissions across the forward link 28 based on the received signal quality messages 38, for increasing channel capacity, as further described below.

The base station 22 utilizes the information provided in the signal quality messages 38 to increase the amount of information that may be transmitted per unit time (i.e., channel capacity) by the base station 22. This may be done in a number of ways.

According to one possible method for adjusting base station transmissions to increase channel capacity, based on the knowledge of which mobile station has the best received signal quality on each frequency band, the base station, on each frequency band, transmits information signals (e.g., voice and other data signals) only to the mobile station with the best signal quality on that frequency band. If several frequency bands are available for transmissions to a mobile station, the base station 22 selects the frequency band with the best-reported signal quality.

This procedure, designated 112a, is shown in FIG. 6. There, at Step 114, the base station 22 identifies those mobile stations 26a-26c with the best received signal quality on each frequency band 34 in the MC cellular network 20. For example, in a first frequency band 34a, a mobile station 26a may have the best received signal quality, and in a second frequency band 34b a mobile station 26b may have the best received signal quality. Then, in Step 116, in each frequency band 34, the base station 22 transmits information signals only to the mobile station with the best signal quality in that frequency band. Returning to the example, in frequency band 34a the base station would transmit information signals only to mobile station 26a, while in frequency band 34b the base station would transmit information signals only to mobile station 26b. As indicated in Step 118, in transmitting a signal to a mobile station on a frequency band, the transmission or transport format (modulation order, code rate, transmit diversity order, etc.) of the signal is adopted to match the reported channel conditions on that band, and compatible with the available transmit power at the base station.

To elaborate regarding Step 118, the modulation order of a transmission signal refers to the amount of information that can be conveyed in a single signal transmission. Higher modulation order transmissions imply the conveyance of more information, and are hence desirable. “Code rate” refers to the ratio of number of information bits to the total transmitted bits including coded/parity bits. A higher code rate implies the conveyance of more information. The ability to successfully carry out transmissions at a certain modulation order and/or code rate is related to the SIR of the link (i.e., frequency band) between the transmitter and the receiver. A higher SIR implies the possibility of utilizing higher order modulations and/or a higher code rate.

FIG. 7 shows the steps of an additional method 112b for adjusting base station transmissions to increase channel capacity. (This method is not applicable to a mobile station 26a-26c that is configured to report the signal quality on only one frequency band.) Based on the signal quality feedback from the mobile station (possibly with respect to “n” frequency bands, where “n,” though larger than unity, may be a subset of the total number of frequency bands 34 in the system), the base station may first determine which “m” frequency bands are suitable for transmission to that mobile station. Here, “m” is a subset of “n,” possibly including all “n” bands. Next, the base station 22 may split the information unit to be transmitted to the mobile station into “m” possibly unequal sub-units. Each of the “m” sub-units is sized, modulated, coded, and a decision taken about the transmit diversity order to use, according to the reported signal conditions on the frequency band on which it is to be transmitted, and compatible with the transmit power available to the base station. This type of operation, in which a transmission unit is split into unequal sub-units adapted to different transmission conditions, is often referred to in the literature as “water pouring.” All of the “m” sub-units are then transmitted simultaneously on the “m” frequency bands. Upon reception, the mobile station may combine the “m” received sub-units to recover the information unit sent. Thus, at Step 120, the base station applies a water-pouring algorithm or similar function to determine how the information signal to the mobile station should be split for transmission across the frequency bands 34, according to the reported frequency band conditions and compatible with the available base station transmit power. The water-pouring algorithm adapts the size, modulation, coding, and transmit diversity order of the sub-signal or sub-unit to be sent on each frequency band to the reported conditions on that band, maintaining compatibility with the available transmit power. Then, at Step 122, the composite coded signal (i.e., the signal intended for a mobile station) is split up according to the water-pouring algorithm, and transmitted across the frequency bands 34.

Upon utilizing either of the methods described above (i.e., as illustrated in FIGS. 6 and 7, respectively) and transmitting the signal to the chosen mobile station with a transmit power deemed sufficient for satisfactory reception, the base station 22 may have additional remaining transmit power. In such a case, the base station may utilize the remaining power to transmit a signal to another chosen mobile station, following either of the methods described above (i.e., again, as illustrated in FIGS. 6 and 7). If the air interface technology used on the forward link 28 permits simultaneous transmissions to different mobile stations on the same frequency band, then the frequency bands selected for transmission to this next chosen mobile station may partially or wholly overlap those selected for transmissions to the first chosen mobile station. A forward link employing CDMA is an instance of such an air interface technology. If the air interface technology used on the forward link 28 does not permit simultaneous transmissions to different mobile stations on the same frequency band, then the frequency bands selected for transmission to this next chosen mobile station will have no overlap with those selected for transmissions to the first chosen mobile station. A forward link employing OFDM (orthogonal frequency division multiplexing) is an example of one type of such an air interface technology. This procedure may be repeated recursively to transmit signals to several mobiles until some closure criteria is reached, e.g., transmit power is exhausted or channelization code is used up, or no more traffic exists for transmission.

Since certain changes may be made in the above-described method for exploiting the diversity across frequency bands of a multi-carrier cellular system or network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of communication with at least one mobile station using a plurality of frequency bands, said method comprising the steps of:
measuring signal quality in at least each of the frequency bands as received at the mobile station; and
transmitting from the mobile station at least one signal quality message, wherein the signal quality message includes information about the measured signal quality in at least one of the frequency bands.

2. The method of claim 1 wherein the step of measuring signal quality comprises measuring a characteristic of a pilot signal in each of the frequency bands.

3. The method of claim 2 wherein the characteristic is a signal-to-interference ratio.

4. The method of claim 3 wherein the signal quality message includes information about the signal-to-interference ratio of the pilot signal having the highest signal-to-interference ratio among the frequency bands.

5. The method of claim 1 wherein the signal quality message includes information about the measured signal quality in all of the frequency bands.

6. The method of claim 5 wherein the signal quality message comprises a plurality of identifiers respectively identifying the frequency bands, and a plurality of quality descriptors respectively relating to the measured signal quality in the frequency bands.

7. The method of claim 1 wherein the signal quality message comprises a quality descriptor relating to the measured signal quality in said at least one of the frequency bands.

8. A method of communication with a base station and at least one of a plurality of mobile stations using a plurality of frequency bands, said method comprising the steps of:
receiving signal quality information at the base station from at least one of the plurality of mobile stations, wherein the signal quality information relates to the signal quality across at least one of the frequency bands as received; and
adjusting communications between the base station and at least one of the mobile stations across the plurality of frequency bands based on the signal quality information.

9. The method of claim 8 further comprising the step of:
transmitting from the base station to the mobile stations a pilot signal on each of the frequency bands.

10. The method of claim 9 wherein the signal quality information relates to a measured characteristic of each of the pilot signals.

11. The method of claim 8 wherein the signal quality information relates to the signal quality across each of the frequency bands as received at the mobile station.

12. The method of claim 8 wherein the step of adjusting communications comprises the sub-steps of:
on each frequency band, identifying a subset of said mobile stations; and
transmitting across that frequency band only to the subset of said mobile stations.

13. The method of claim 12 wherein the sub-step of identifying a subset of said mobile stations comprises determining which of the plurality of mobile stations has the best received signal quality across the frequency band.

14. The method of claim 8 wherein the step of adjusting communications comprises transmitting signals to one or more of the mobile stations across one or more of the frequency bands simultaneously, wherein transmissions on each frequency band are adapted to the corresponding conditions of that frequency band.

15. The method of claim 14 further comprising the step of, on each frequency band, adopting a transport format of the signals to match the channel conditions of that frequency band.

16. The method of claim 8 wherein the step of adjusting communications comprises the sub-steps of:
determining a manner in which to split signals intended for transmission to the mobile stations, according to frequency band conditions; and
splitting and transmitting the signals to one or more of the mobile stations across one or more of the frequency bands simultaneously.

17. The method of claim 16 wherein the step of adjusting communications further comprises the sub-step of:
on each frequency band, adopting a transport format of the signals to match the channel conditions of that frequency band.

18. A method of communication utilizing a plurality of frequency bands between at least one base station and at least one of a plurality of mobile stations, said method comprising the steps of:
measuring signal quality in each of the frequency bands as received;
transmitting at least one signal quality message, wherein the signal quality message comprises information about the measured signal quality in one or more of the frequency bands; and
adjusting communications across the plurality of frequency bands based on the signal quality messages.

19. The method of claim 18 further comprising the step of:
transmitting from the base station to the mobile stations a pilot signal on each of the frequency bands, wherein the signal quality message from each mobile station relates to a measured characteristic of one or more of the pilot signals.

20. The method of claim 18 wherein the signal quality message comprises, for each frequency band, an implied or explicit identifier and a quality descriptor relating to the measured signal quality in that frequency band.
